(19) United States
(12) Patent Application Publication
(10) Pub. No.: US 2026/0355868 A1
(43) Pub. Date: Nov. 12, 2026

(54) HANDHELD WELDING TORCH MOUNTING STRUCTURE

(71) Applicant: AMADA CO., LTD., Kanagawa (JP)

(72) Inventors: Kazutaka SATO, Kanagawa (JP); Kazuya HAYASHIMOTO, Kanagawa (JP); Naotoshi OYAMA, Kanagawa (JP)

(73) Assignee: AMADA CO., LTD., Kanagawa (JP)

(21) Appl. No.: 19/515,335

(22) PCT Filed: Aug. 29, 2024
(86) PCT No.: PCT/JP2024/031060

§ 371 Date: Feb. 27, 2026

(30) Foreign Application Priority Data
Sep. 13, 2023 (JP) 2023-148249

(51) Int. Cl. B23K 37/02

(52) U.S. Cl. CPC B23K 37/0229

(57) ABSTRACT

A handheld welding torch mounting structure includes a mounting portion fixed to an arm of a robot, a rectangular base plate formed integrally with the mounting portion for placing a handheld welding torch, a first side plate supported on a first edge of the base plate so as to be rotatable in an opening direction from an upright posture, and a second side plate fixed in an upright posture to a second edge opposite to the first edge. The handheld welding torch is mounted on the arm by being clamped and held between the first side plate and the second side plate raised in a state of being placed on the base plate.

### TECHNICAL FIELD

The present invention relates to a handheld welding torch mounting structure.

### BACKGROUND ART

A technique for performing automatic welding by attaching a welding torch to the tip of an arm of an articulated robot is known and is described in Patent Literature 1.

### CITATION LIST

### Patent Literature

Patent Literature 1: Japanese Patent Application Laid-Open No. H8-25274

### SUMMARY OF INVENTION

### Technical Problem

As a welding torch, there is a so-called handheld welding torch that can be gripped by hand by an operator to perform welding. It would be useful to attach this handheld welding torch to the tip of an arm of an articulated robot so that it can also be used for automatic welding. However, since the handheld welding torch has a characteristic shape that can be gripped by hand, it is currently difficult to mount it on the arm of a robot that repeatedly starts and stops moving with large acceleration without causing rattling and the like over a long period of time. Therefore, a handheld welding torch mounting structure that can reliably mount the handheld welding torch on the arm of the robot without rattling and positional displacement is desired.

### Technical Solution

A handheld welding torch mounting structure according to one aspect of the present invention comprises a mounting portion fixed to an arm of a robot, a rectangular base plate formed integrally with the mounting portion for placing a handheld welding torch, a first side plate supported on a first edge of the base plate so as to be rotatable in an opening direction from an upright posture, and a second side plate fixed in an upright posture to a second edge opposite to the first edge, wherein the handheld welding torch is mounted on the arm by being clamped and held between the first side plate and the second side plate raised in a state of being placed on the base plate.

In the handheld welding torch mounting structure according to this aspect, the handheld welding torch is clamped from the left and right by the first side plate and the second side plate, and is held. Therefore, the handheld welding torch can be reliably mounted without rattling and positional displacement.

### Effect of the Invention

According to the handheld welding torch mounting structure according to one aspect of the present invention, the handheld welding torch can be reliably mounted on the arm of the robot without causing rattling and positional displacement.

### BRIEF DESCRIPTION OF DRAWINGS

FIG. 1 is a schematic diagram showing an example of a usage form of a mounting structure SK for a handheld welding torch according to an embodiment of the present invention.

FIG. 2A is a left side view of the torch 7.

FIG. 2B is a front view of the torch 7.

FIG. 3A is a left side view of the torch mounting portion 1.

FIG. 3B is a right side view of the torch mounting portion 1.

FIG. 3C is a front view of the torch mounting portion 1.

FIG. 4A is a left side view showing a state in which the torch 7 is mounted on the torch mounting portion 1.

FIG. 4B is a right side view showing a state in which the torch 7 is mounted on the torch mounting portion 1.

FIG. 4C is a front view showing a state in which the torch 7 is mounted on the torch mounting portion 1.

FIG. 5A is a schematic left side view showing forces applied to the torch 7 by the torch mounting portion 1.

FIG. 5B is a front view showing forces applied to the torch 7 by the torch mounting portion 1.

FIG. 6 is a block diagram showing the configuration of the torch 7 and the torch control unit 62.

FIG. 7 is a left side view for explaining a torch mounting portion 1A as a modified example.

### DESCRIPTION OF EMBODIMENTS

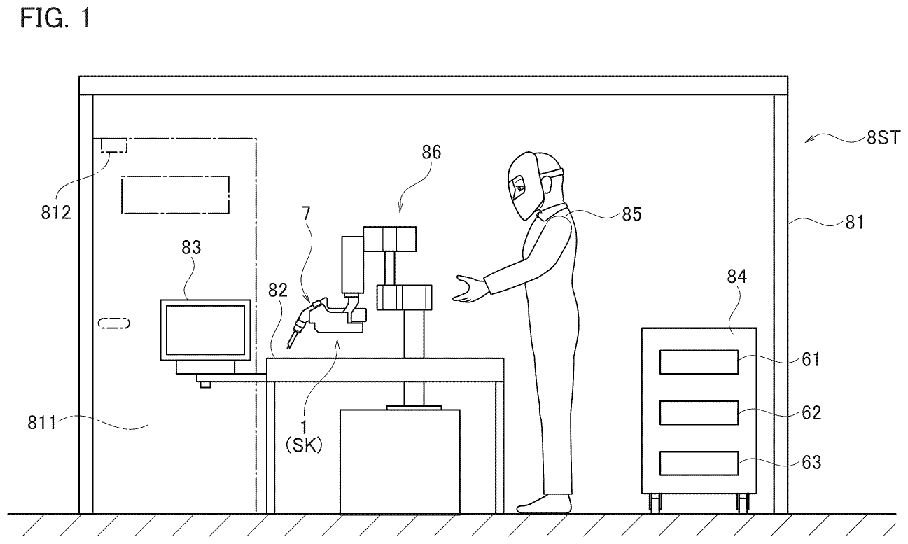

A torch mounting portion 1 provided with a handheld welding torch mounting structure SK according to an embodiment of the present invention will be described. The torch mounting portion 1 is attached to the arm of an articulated robot 86 in a laser welding room 8ST as shown in FIG. 1, for example.

FIG. 1 is a schematic diagram showing an articulated robot 86 on which a handheld welding torch 7 is mounted by the handheld welding torch mounting structure SK. The articulated robot 86 is housed in a laser welding room 8ST. The laser welding room 8ST is a room partitioned by a partition 81 having a door 811 and in which leakage of a laser beam to the outside is prevented. Hereinafter, the handheld welding torch 7 is also simply referred to as the torch 7.

Inside the laser welding room 8ST, a jig table 82, an input/output device 83, a control device 84, and an articulated robot 86 are arranged. An operator 85 enters and exits through the door 811. The torch 7 is attached to the arm at the tip of the articulated robot 86 via the torch mounting portion 1 provided with the handheld welding torch mounting structure SK.

The control device 84 has a robot control unit 61, a torch control unit 62, and a laser generator 63. The jig table 82 is where a workpiece (member to be welded) or the like to be welded is fixed. The articulated robot 86 is a robot in which a plurality of arms are rotatably connected in series, and its operation is controlled by the robot control unit 61 provided in the control device 84.

The torch 7 is a so-called handheld welding torch that can be gripped by hand by the operator 85, and is attached to the tip of the arm of the articulated robot 86 via the torch mounting portion 1. The operation of the torch 7 is controlled by the torch control unit 62.

The torch control unit 62 and the robot control unit 61 respectively control the operations of the torch 7 and the articulated robot 86, and their control is linked by a coordinated control unit (not shown). The coordinated control unit causes the input/output device 83 to output the control status of the torch control unit 62 and the robot control unit 61, as well as the operation status of the torch 7 and the articulated robot 86. The input/output device 83 has, for example, a display as an output device, and has a keyboard or a touch panel mounted on the display as an input device

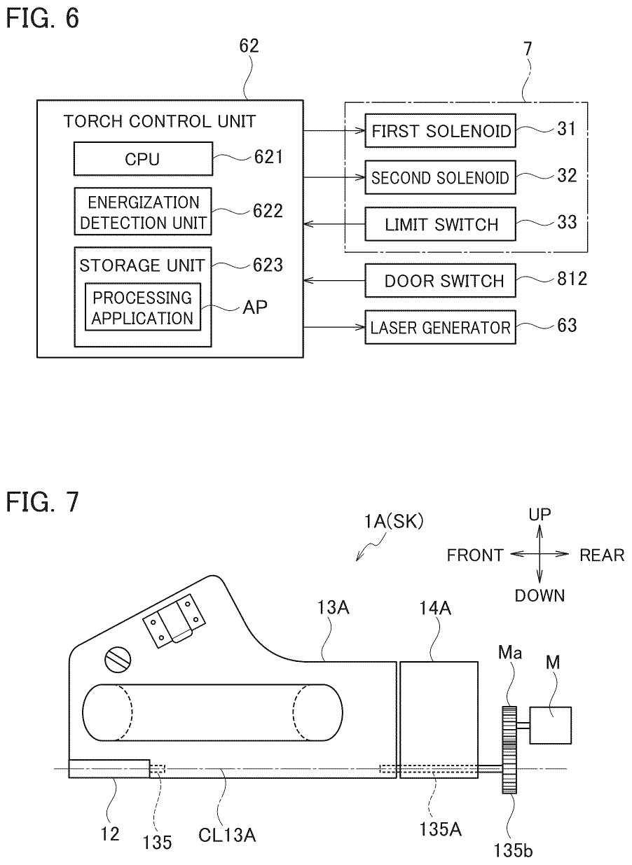

As shown in FIG. 6, the torch control unit 62 includes a CPU (Central Processing Unit) 621 which is a central processing unit, an energization detection unit 622, and a storage unit 623. The storage unit 623 stores a processing application AP, and the processing application AP provides a welding program related to the member to be welded placed on the jig table 82 to the torch control unit 62 and the robot control unit 61 to execute welding by cooperation between the torch 7 and the articulated robot 86.

### Torch 7

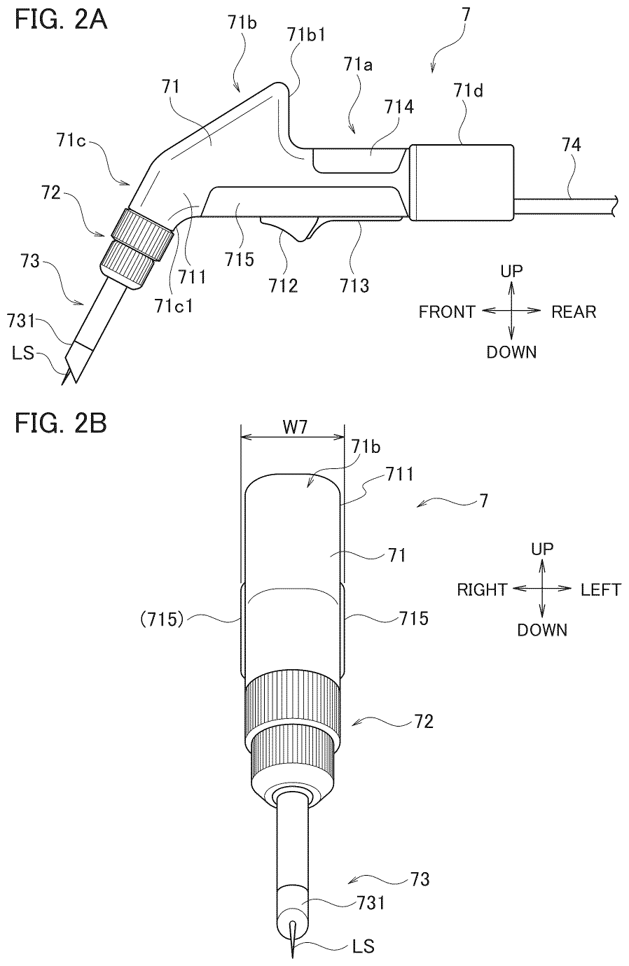

The torch 7 will be described with reference to FIGS. 2A and 2B. FIG. 2A is a left side view of the torch 7. FIG. 2B is a front view of the torch 7. In the following description, the up-down, left-right, and front-rear directions are defined as the directions indicated by arrows in each figure. These up-down, left-right, and front-rear directions are set for convenience of explanation and do not limit the directions in the usage posture or configuration of the torch 7.

The torch 7 is a torch that can be gripped with one hand and emits a laser beam LS by a fiber laser from the tip. The torch 7 has a body portion 71, a nozzle chuck portion 72, and a nozzle 73. A fiber cable 74 that supplies a laser beam output from the laser generator 63 is connected from the rear end portion of the body portion 71. The laser beam supplied from the fiber cable 74 passes through an optical system (not shown) housed inside the body portion 71 and is emitted to the outside as a laser beam LS from the tip of the nozzle 73.

The body portion 71 has a housing 711. The housing 711 is formed with a cross-sectional shape that is thin in the left-right direction which is the width direction and long (tall) in the up-down direction, having a substantially rectangular flat shape. The housing 711 has, in the front-rear direction from the rear side, a cable support portion 71d, a grip portion 71a, a protruding portion 71b, and a tip portion 71c.

The cable support portion 71d is a portion to which the fiber cable 74 is connected, and the grip portion 71a is a portion formed with a thickness and a cross-sectional shape that can be gripped by hand. The protruding portion 71b has a chevron portion 71b1 that houses an optical system such as a mirror and protrudes upward in a triangular chevron shape. The chevron portion 71b1 is a portion that fits between the thumb and index finger when the grip portion 71a is gripped by hand to stabilize the grip.

The tip portion 71c is a portion that is inclined downward toward the tip when the grip portion 71a is in the posture of FIG. 2A extending horizontally in the front-rear direction. The nozzle chuck portion 72 is provided at the tip of the tip portion 71c. The nozzle chuck portion 72 clamps and attaches the nozzle 73 in a detachable manner in a posture extending in the same inclination direction as the tip portion 71c. The nozzle 73 is a rod-shaped member, and the tip is a carbon chip portion 731. The laser beam LS is emitted from the tip of the carbon chip portion 731.

A trigger knob 712 and a contact portion 713 are provided on the bottom surface of the housing 711. The trigger knob 712 is located at a position where the index finger is placed when the grip portion 71a is gripped by hand, and in a state where the laser beam LS can be emitted, when the trigger knob 712 is pulled with the index finger so as to push it inside the housing 711, the laser beam LS is emitted, and when the finger is released, it returns to the original position and the emission of the laser beam LS stops. The contact portion 713 is a portion that is electrically connected to the carbon chip portion 731 of the nozzle 73, and is a portion that a rod 321 of a second solenoid 32 described later contacts. Non-slip pads 714 and 715 are attached by pasting or the like to the upper part of the grip portion 71a and the lower part from the grip portion 71a to the protruding portion 71b, respectively.

As shown in FIG. 2B, the maximum width in the left-right direction of the housing 711 is the distance between the left and right outer surfaces of the non-slip pad 715, and this is defined as the housing width W7.

### Torch Mounting Portion 1

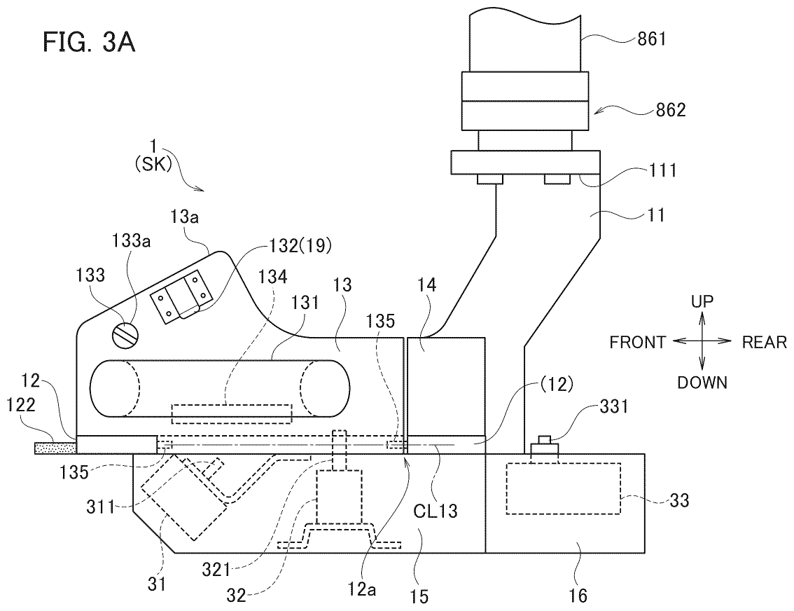

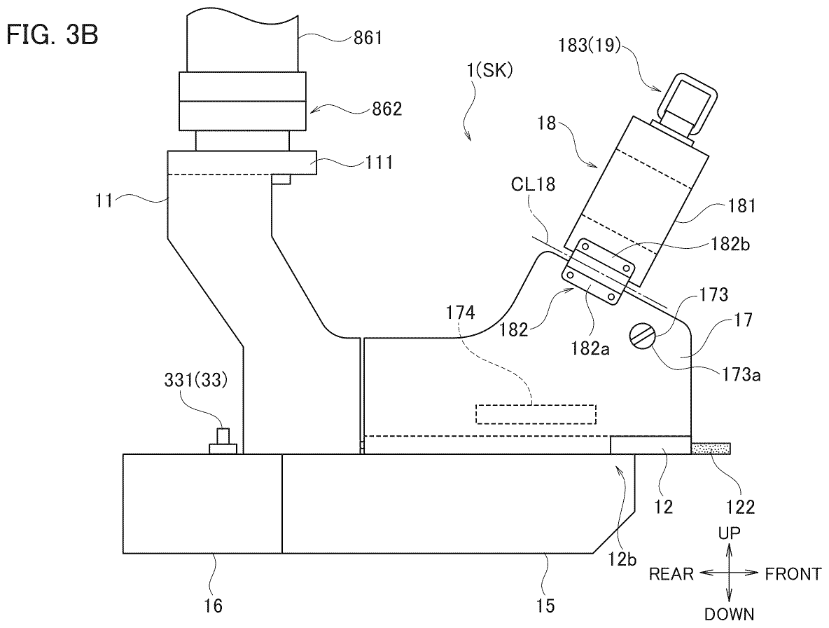

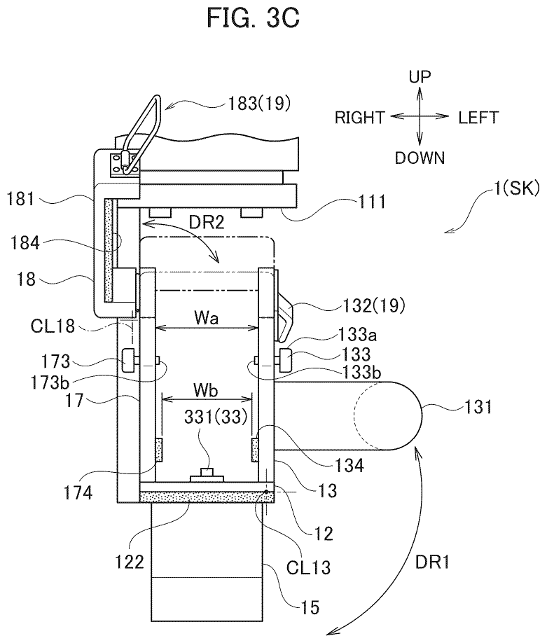

Next, the torch mounting portion 1 will be described with reference to FIGS. 3A to 3C. FIG. 3A is a left side view of the torch mounting portion 1, FIG. 3B is a right side view of the torch mounting portion 1, and FIG. 3C is a front view of the torch mounting portion 1.

The articulated robot 86 has a tip arm portion 861 that is the most advanced of the plurality of arms. In FIGS. 3A to 3C, the tip arm portion 861 is described as being in a posture extending in the up-down direction with its tip facing downward. An attachment 862 is attached to the tip of the tip arm portion 861. The attachment 862 is a member that enables a flat plate to be fixed to the tip arm portion 861 with bolts. Hereinafter, the tip arm portion 861 is also simply referred to as the arm 861.

The torch mounting portion 1 includes an arm plate 11, a base plate 12, a first side plate 13, a side plate 14, a second side plate 17, a clamp plate 18, a bottom box portion 15, and a rear box portion 16. The arm plate 11 has a plate-shaped mounting portion 111 in a horizontal posture at the upper end, and is a plate-shaped member extending downward in the up-down and front-rear directions from the right edge of the mounting portion 111. The mounting portion 111 is fastened and fixed to the attachment 862 with bolts.

The base plate 12 is a plate-shaped member fixed to the left surface of the lower end of the arm plate 11 and extending horizontally with the front-rear direction as the longitudinal direction. The base plate 12 is formed in a substantially rectangular shape in top view. A flat plate-shaped front cushion 122 that protrudes forward is attached to the front end surface of the base plate 12. The front cushion 122 is formed of, for example, low-resilience rubber.

The first side plate 13 is rotatably supported around an axis CL13 extending horizontally in the front-rear direction by a pair of pins 135 fixed to the base plate 12 at the left edge 12a (see FIG. 3A) of the base plate 12 (see arrow DR1 in FIG. 3C). The left edge 12a is the first edge in this example. In FIGS. 3A and 3C, the first side plate 13 is shown in an upright posture. The first side plate 13 is formed in a shape having a protruding edge portion 13a in which the rear side is substantially rectangular and the front side protrudes upward in a triangular shape in the upright posture.

A handle 131, a hook receiving portion 132, and a bolt 133 are attached to the outer surface of the first side plate 13. The handle 131 can be gripped by hand and facilitates the operation of manually changing the posture of the torch mounting portion 1 when the torch mounting portion 1 is attached to the tip arm portion 861.

The hook receiving portion 132 is attached to the upper part of the protruding edge portion 13a, and a hook portion 183 attached to the clamp plate 18 is hooked and locked. That is, the hook receiving portion 132 and the hook portion 183 constitute a so-called snap lock 19.

The bolt 133 has a head 133a that can be picked by hand and a shaft portion 133b on which a male thread is formed, and is screwed into the first side plate 13 so as to be able to advance and retreat in the left-right direction. The bolt 133 is a resin bolt formed of, for example, resin. When the bolt 133 is tightened and screwed, the shaft portion 133b penetrates the first side plate 13 and protrudes inward. A first cushion 134 that is long in the front-rear direction is attached to the lower part of the inner surface of the first side plate 13. The first cushion 134 is formed of, for example, low-resilience rubber. The side plate 14 is a plate-shaped member that is fixed to the base plate 12 and fixed in a posture extending in the front-rear and up-down directions.

As shown in FIG. 3B, the second side plate 17 has substantially the same external shape and size as the first side plate 13. The second side plate 17 is fixed to the right edge 12b of the arm plate 11 in an upright posture extending up-down and front-rear by a set screw (not shown). The right edge 12b is the second edge in this example. A base portion 182a of a hinge 182 and a bolt 173 are attached to the outer surface of the second side plate 17. The clamp plate 18 is attached to a rotating portion 182b that rotates relative to the base portion 182a of the hinge 182. As a result, the clamp plate 18 is rotatable around an axis CL18 along the outer shape of the second side plate 17 of the hinge 182 (see arrow DR2 in FIG. 3C).

The clamp plate 18 has a base portion 181 (see FIG. 3C) and a pair of side portions, and has a flat U-shaped cross-sectional shape. The distance between the inner surfaces of the pair of side portions is equal to the distance between the inner surfaces of the first side plate 13 and the second side plate 17 in the upright posture. The rotating portion 182b of the hinge 182 is fixed to the outer surface of one of the pair of side portions of the clamp plate 18. A hook portion 183 is fixed to the outer surface of the other of the pair of side portions. The hook portion 183 is hooked and locked to the hook receiving portion 132 of the first side plate 13. As a result, as shown in FIG. 3C, when the clamp plate 18 is rotated clockwise around the axis CL18 as an axis, the pair of side portions abut against the upper end surfaces of the first side plate 13 and the second side plate 17, respectively, and further, the hook portion 183 can be hooked onto the hook receiving portion 132 and fixed. That is, an integrated gate-shaped shape can be formed in front view by the first side plate 13, the clamp plate 18, and the second side plate 17.

With the first side plate 13 raised parallel to the second side plate 17, the axis of the bolt 133 and the axis of the bolt 173 coincide.

As shown in FIG. 3A, the bottom box portion 15 is a box-shaped portion attached to the lower surface of the base plate 12. Inside the bottom box portion 15, a first solenoid 31 and a second solenoid 32 are housed and fixed. The first solenoid 31 and the second solenoid 32 have rods 311 and 321, respectively, that move in and out independently under the control of the torch control unit 62.

The rear box portion 16 is a box-shaped portion connected to the rear part of the bottom box portion 15 in a state of protruding from the base plate 12. Inside the rear box portion 16, a limit switch 33 is housed and fixed. A contactor 331 of the limit switch 33 protrudes upward from the upper surface of the rear box portion 16. The limit switch 33 is turned ON when the contactor 331 is pushed downward. The limit switch 33 outputs a signal indicating ON to the torch control unit 62.

Here, as shown in FIG. 3C, with the first side plate 13 raised parallel to the second side plate 17, the distance between the inner surfaces in the left-right direction between the first side plate 13 and the second side plate 17 is defined as a distance Wa, and the distance between the inner surfaces in the left-right direction between the first cushion 134 and the second cushion 174 is defined as a distance Wb. The distance Wa is larger than the housing width W7 (see FIG. 2B) of the torch 7, and the distance Wb is smaller than the housing width W7.

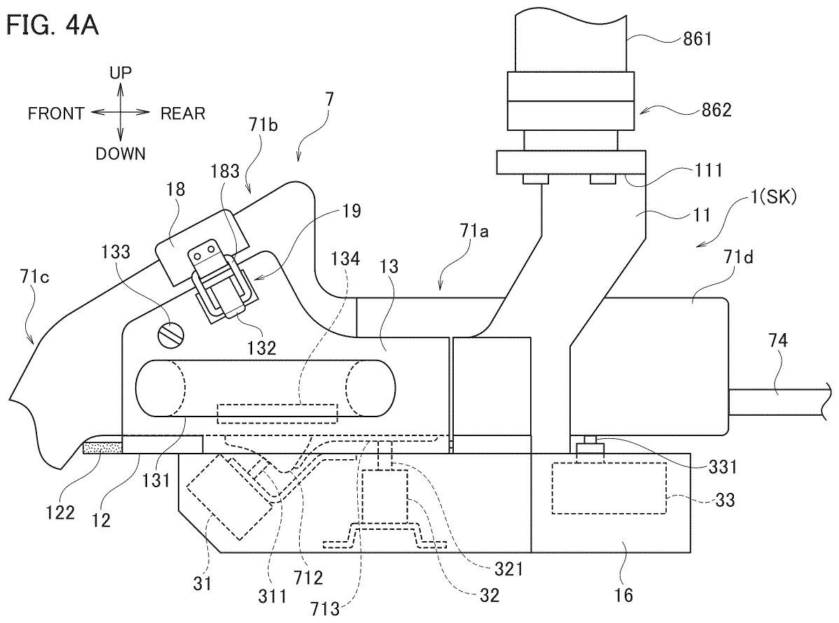

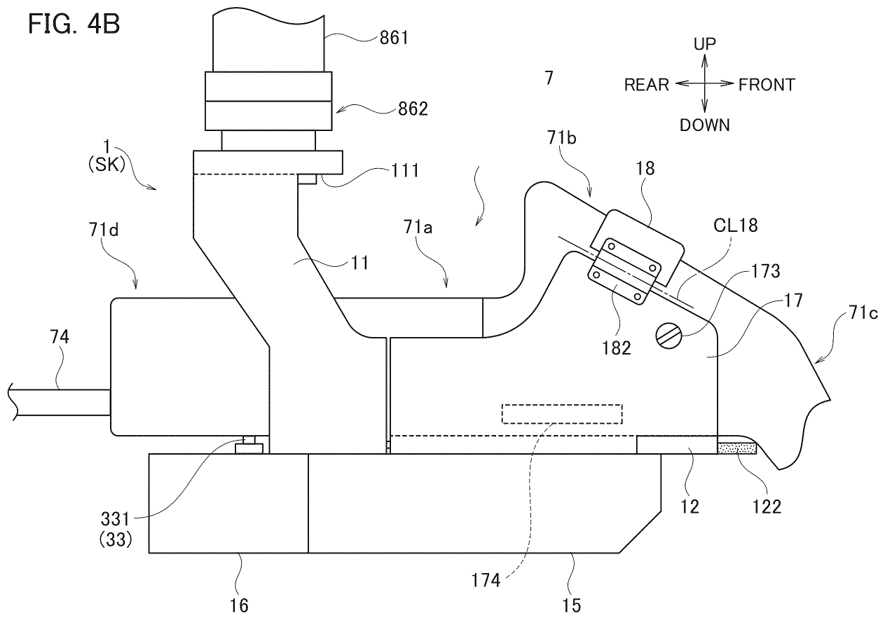

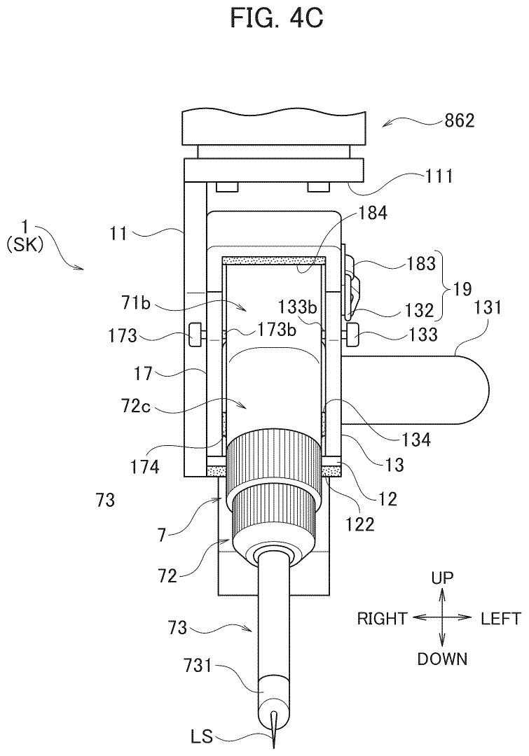

Next, the mounting of the torch 7 on the torch mounting portion 1 will be described with reference to FIGS. 4A to 4C. FIG. 4A is a left side view showing a state in which the torch 7 is mounted on the torch mounting portion 1. FIG. 4B is a right side view showing a state in which the torch 7 is mounted on the torch mounting portion 1. FIG. 4C is a front view showing a state in which the torch 7 is mounted on the torch mounting portion 1.

First, regarding the torch mounting portion 1, the clamp plate 18 is rotated counterclockwise as shown in FIGS. 3B and 3C to be in an open state. Also, the first side plate 13 is rotated clockwise in FIG. 3C to be in an open state. Then, the operator 85 places the torch 7 on the base plate 12 of the torch mounting portion 1 so as to apply it to the second side plate 17 from the upper left diagonally.

Since the first side plate 13 and the clamp plate 18 are open, the torch 7 can be easily placed on the base plate 12. More specifically, the non-slip pad 715 on the right side surface of the torch 7 is pressed against the second cushion 174 of the second side plate 17, and the surface 71c1 (see FIG. 2A) which is the inner surface of the tip portion 71c of the body portion 71 is placed on the base plate 12 at a position where it abuts against the front cushion 122 attached to the front end of the base plate 12. At this time, the contactor 331 of the limit switch 33 of the rear box portion 16 is pushed in by the bottom surface of the cable support portion 71d of the torch 7, and the limit switch 33 is turned ON.

The rod 311 of the first solenoid 31 is in a retracted position that is close to and separated from the trigger knob 712 of the torch 7. The rod 321 of the second solenoid 32 is in a retracted position that is separated from the contact portion 713.

After placing the torch 7 on the base plate 12, the first side plate 13 is rotated counterclockwise in FIG. 3C to close it. That is, the first side plate 13 is set to the upright posture shown in FIGS. 4A to 4C. Next, the clamp plate 18 is closed, and the hook portion 183 is hooked onto the hook receiving portion 132 and locked. As a result, the upper cushion 184 attached to the base portion 181 of the clamp plate 18 presses the upper surface of the protruding portion 71b of the torch 7 diagonally downward and rearward. Further, since the distance Wb is smaller than the housing width W7, the first cushion 134 of the first side plate 13 and the second cushion 174 of the second side plate 17 are elastically compressed, and the body portion 71 of the torch 7 is pressed so as to be sandwiched from the left and right by their repulsive force.

On the other hand, since the distance Wa (see FIG. 3C) is larger than the housing width W7, gaps are formed between the first side plate 13 and the second side plate 17 and the housing 711. In response to this, the operator 85 tightens the bolt 133 and the bolt 173 to screw the shaft portion 133b and the shaft portion 173b, respectively, and tightens them so as to press the housing 711 from the left and right. As a result, the torch 7 is pressed from the left and right direction at both the lower part and the upper part against the first side plate 13 and the second side plate 17, so that rattling and positional displacement in the left-right direction do not occur. Further, by making the bolts 133 and 173 resin bolts, the housing 711 is less likely to be scratched.

As described above, by placing the torch 7 on the base plate 12 with the first side plate 13 and the clamp plate 18 open, raising (closing) the first side plate 13, and closing the clamp plate 18 and locking the snap lock 19, the torch 7 is firmly mounted on the torch mounting portion 1.

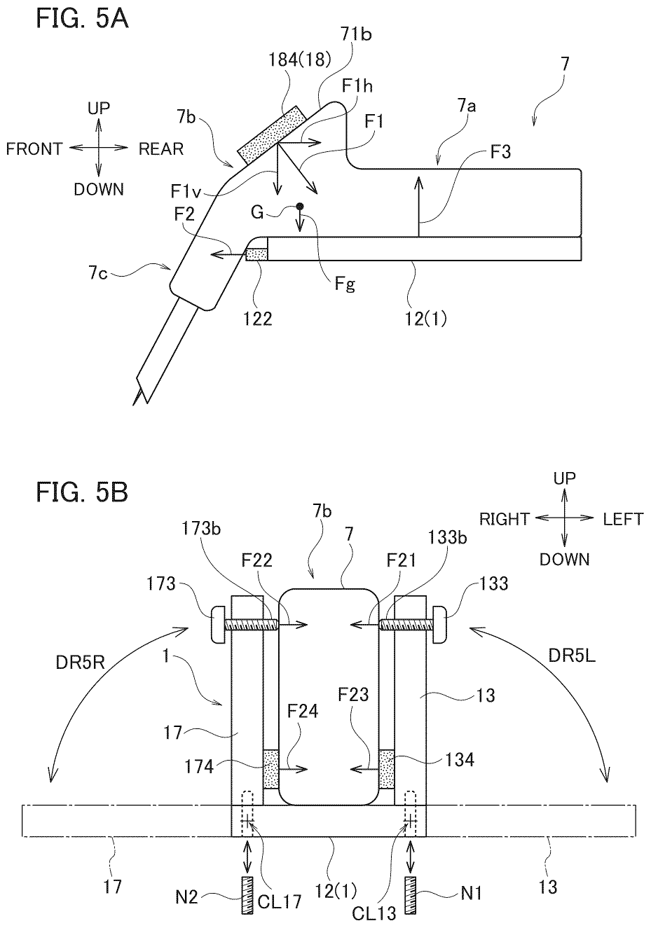

How forces are applied to the torch 7 when the torch 7 is mounted on the torch mounting portion 1 will be described with reference to FIGS. 5A and 5B. FIG. 5A is a schematic left side view showing forces applied to the torch 7 by the torch mounting portion 1. FIG. 5B is a front view showing forces applied to the torch 7 by the torch mounting portion 1.

FIG. 5A schematically shows forces in the up-down and front-rear directions among the forces applied to the torch 7. The torch 7 is in contact with the upper cushion 184 attached to the clamp plate 18, the base plate 12, and the front cushion 122 attached to the base plate 12. A dead weight Fg due to gravity is applied to the center of gravity G of the torch 7.

In this state, a force F1 directed diagonally downward and rearward perpendicular to the inclination direction of the protruding portion 71b is applied to the torch 7 from the upper cushion 184. The force F1 is decomposed into a component force F1v directed downward and a component force F1h directed rearward. With respect to the component force F1h directed rearward, a force F2 directed forward is applied to the torch 7 as a reaction force from the front cushion 122 to be in a balanced state. With respect to the resultant force of the component force F1v directed downward and the dead weight Fg, a force F3 directed upward is applied as a reaction force from the base plate 12 to be in a balanced state.

As is clear from FIG. 5A, the forces in the front-rear direction and the up-down direction on the torch 7 are balanced. In addition, the front-rear and left-right movement (linear movement) and rotation of the torch 7 due to unintended application of external force are regulated by the upper cushion 184, the front cushion 122, and the base plate 12. Therefore, the torch 7 does not substantially rattle and positionally displace in the front-rear direction and the up-down direction with respect to the torch mounting portion 1.

FIG. 5B schematically shows forces in the left-right direction among the forces applied to the torch 7. The torch 7 is given a force F23 directed to the right, which is the compression repulsion force of the first cushion 134 of the first side plate 13, and a force F24 directed to the left, which is the compression repulsion force of the second cushion 174 of the second side plate 17. On the other hand, at the upper part, a force F21 directed to the right by the tightening of the bolt 133 and a force F22 directed to the left by the tightening of the bolt 173 are applied.

Since the force F21 and the force F22 are clamping forces in opposite directions applied coaxially to the torch 7, they naturally balance each other. Further, the force F23 and the force F24 are self-adjusted and balanced so that the compression degree of the first cushion 134 and the second cushion 174 becomes equal. Therefore, the forces in the left-right direction on the torch 7 are balanced coaxially, and the torch 7 does not move (linearly) in the left-right direction with respect to the torch mounting portion 1 and does not rotate. Further, even if an unintended external force in the left-right direction is applied to the torch 7, the torch 7 is sandwiched in the left-right direction at both the lower part and the upper part, so linear movement and rotation are regulated. Therefore, the torch 7 does not substantially rattle and positionally displace in the left-right direction with respect to the torch mounting portion 1.

In this way, the forces in the up-down, left-right, and front-rear directions applied to the torch 7 are each balanced, and linear movement and rotation are regulated even against unintended external forces, so the torch 7 does not move in any direction after being mounted on the torch mounting portion 1, and rotation does not occur. Therefore, the torch mounting portion 1 having the handheld welding torch mounting structure SK can reliably mount the torch 7 on the tip arm portion 861 of the articulated robot 86 without causing rattling and positional displacement.

The emission of the laser beam LS when the torch 7 is mounted on the torch mounting portion 1 is performed based on the following procedure. As shown in FIG. 6, signals from the limit switch 33 and a door switch 812 are input to the torch control unit 62.

The torch control unit 62 prohibits the emission of the laser beam LS in any case when it determines that the door 811 is open based on a signal indicating the open/closed state of the door 811 input from the door switch 812. When the door 811 is closed and it is determined that the torch 7 is placed on the torch mounting portion 1 based on the signal from the limit switch 33, the second solenoid 32 is operated to bring the rod 321 into contact with the contact portion 713 of the torch 7 to establish an electrically conductive state.

The contact portion 713 and the carbon chip portion 731 at the tip of the nozzle 73 are electrically connected. The energization detection unit 622 operates the second solenoid 32 to push out the rod 321, and when the rod 321 comes into contact with the contact portion 713 of the torch 7, starts monitoring the presence or absence of electrical continuity between the rod 321 and the jig table 82.

When the member to be welded is a conductive material such as iron, when the carbon chip portion 731 of the torch 7 contacts a welding site of the member to be welded for welding, the contact portion 713, the carbon chip portion 731, the member to be welded, and the jig table 82 become electrically conductive, so the energization detection unit 622 detects that the state has changed from a non-conductive state to a conductive state.

When the energization detection unit 622 detects a conductive state, that is, contact between the nozzle 73 and the member to be welded, the CPU 621 immediately puts the laser generator 63 into a state in which it can output a laser beam. When an emission start command is issued from the processing application AP in this state, the CPU 621 causes the first solenoid 31 to perform an operation of pushing out the rod 311 to push in the trigger knob 712 with the rod 311. As a result, the laser beam LS is emitted from the tip of the nozzle 73 of the torch 7. Further, when an emission stop command is issued from the processing application AP, the first solenoid 31 is caused to perform an operation of retracting the rod 311 to return the trigger knob 712 to the original position. As a result, the emission of the laser beam LS from the tip of the nozzle 73 stops.

The present embodiment is not limited to the configuration and procedure described above, and may be modified without departing from the scope of the present invention.

The ON/OFF operation of the trigger knob 712, the detection of contact between the tip of the nozzle 73 and the member to be welded, and the confirmation of mounting of the torch 7 on the torch mounting portion 1 may be performed electronically. That is, the torch 7 and the torch control unit 62 are connected by a cable so that signals can be transmitted and received, and the laser beam LS is emitted from the tip of the nozzle 73 by an emission signal from the torch control unit 62 regardless of the operation of the trigger knob 712. Further, the continuity of the carbon chip portion 731 may be detected directly without going through the contact portion 713, and the mounting confirmation on the torch mounting portion 1 may be performed by a sensor. In this case, the first solenoid 31, the second solenoid 32, and the limit switch 33 are not necessary in the torch mounting portion 1.

The structure in which the first side plate 13 on the left side opens and closes and the second side plate 17 on the right side is fixed in an upright posture as the torch mounting portion 1 has been described, but the reverse may be applied. That is, instead of the structure shown in FIG. 5B in which the first side plate 13 can be opened and closed (see arrow DR5L) and the second side plate 17 is fixed to the base plate 12 with a lock bolt N2, for example, the second side plate 17 may be rotatably supported by a pin (not shown) so that it can be opened and closed as indicated by arrow DR5R, and the first side plate 13 may be fixed with a lock bolt N1. In this case, the handle 131 (see FIG. 3C) is preferably attached to a side plate that can be opened and closed. In this way, the torch mounting portion 1 can be configured to be easy to work with according to the dominant arm of the operator 85. In this case, the left edge 12a becomes the second edge, and the right edge 12b becomes the first edge.

The first side plate 13 that opens and closes may be locked in an upright posture by a releasable lock mechanism (not shown). In this case, the snap lock 19 is not necessary, and as shown in FIG. 5B, the clamp plate 18 may not be provided. When the clamp plate 18 is not provided, the force that restricts the movement of the torch 7 in the front-rear direction and the up-down direction is borne by the frictional force due to the forces F21 to F24 in the left-right direction, so this can be applied when the mass of the torch 7 is relatively small and when the acceleration of the torch 7 caused by the operation of the articulated robot 86 is not excessively large.

The torch mounting portion 1 is not limited to a structure in which the first side plate 13 is manually opened and closed, and may be a modified example of a torch mounting portion 1A in which the opening and closing can be performed automatically. This will be described with reference to FIG. 7. FIG. 7 is a left side view for explaining the torch mounting portion 1A as a modified example.

In the torch mounting portion 1A, a side plate 13A that opens and closes around an axis CL13A is rotatably supported on the front side by a pin 135, and has an elongated shaft 135A fixed to the side plate 13A on the rear side. The shaft 135A extends on the axis CL13A, rotatably penetrates through the side plate 14A, and protrudes rearward. A gear 135b is attached to the rear end of the shaft 135A. A pinion Ma meshes with the gear 135b, and the pinion Ma is fixed to the drive shaft of a motor M, which is, for example, a stepping motor and whose operation is controlled by the control device 84. As a result, the opening and closing of the side plate 13A is automatically performed by the driving force of the motor M whose operation is controlled by the control device 84. The drive source for opening and closing is not limited to a motor. Further, the power transmission method may be a structure that transmits power using a belt or a link mechanism instead of gears. The articulated robot 86 does not have to have an articulated structure, and may be an articulated or single-joint robot.

As described in detail above, the handheld welding torch mounting structure according to the present embodiment includes a mounting portion 111 fixed to the arm 861 of the robot 86, a rectangular base plate 12 formed integrally with the mounting portion 111 for placing the handheld welding torch 7, a first side plate 13 supported on a first edge of the base plate 12 so as to be rotatable in an opening direction from an upright posture, and a second side plate 17 fixed in an upright posture to a second edge opposite to the first edge, wherein the handheld welding torch 7 is mounted on the arm 861 by being clamped and held between the first side plate 13 and the second side plate 17 raised in a state of being placed on the base plate 12.

The handheld welding torch 7 is clamped and held by the first side plate 13 and the second side plate 17 in a state of being placed on the base plate 12. Therefore, the movement of the handheld welding torch 7 is restricted from three directions. Therefore, the handheld welding torch 7 can be firmly mounted on the arm 861.

Further, the handheld welding torch mounting structure may have a clamp plate 18 that connects and fixes the first side plate 13 and the second side plate 17.

As a result, the first side plate 13 and the second side plate 17 are firmly integrated, and it becomes possible to press the handheld welding torch 7 from above with the clamp plate 18, so that the handheld welding torch 7 can be more firmly mounted on the arm 861.

Furthermore, each of the first side plate 13 and the second side plate 17 may have bolts 133 and 173 that tighten the clamped handheld welding torch 7 by being screwed.

As a result, since the handheld welding torch 7 is more strongly clamped in the width direction, the handheld welding torch 7 can be more firmly mounted on the arm 861.

Further, the bolts 133 and 173 may be resin bolts.

As a result, the tightened portion of the handheld welding torch 7 is less likely to be scratched.

### REFERENCE SIGNS LIST

1, 1A torch mounting portion
11 arm plate
111 mounting portion
12 base plate
12a left edge
12b right edge
122 front cushion
13 first side plate
13A side plate
13a protruding edge portion
131 handle
132 hook receiving portion
133 bolt
133a head
133b shaft portion
134 first cushion
135 pin
135A shaft
135b gear
14, 14A side plate
15 bottom box portion
16 rear box portion
17 second side plate
173 bolt
173b shaft portion
174 second cushion
18 clamp plate
181 base portion
182 hinge
182a base portion
182b rotating portion
183 hook portion
184 upper cushion
19 snap lock
31 first solenoid
311 rod
32 second solenoid
321 rod
33 limit switch
331 contactor
61 robot control unit
62 torch control unit
621 CPU (central processing unit)
622 energization detection unit
623 storage unit
63 laser generator
7 torch (handheld welding torch)
71 body portion
71a grip portion
71b protruding portion
71b1 chevron portion
71c tip portion
71c1 surface
71d cable support portion
711 housing
712 trigger knob
713 contact portion
714, 715 non-slip pad
72 nozzle chuck portion
73 nozzle
731 carbon chip portion
74 fiber cable
8ST laser welding room
81 partition
811 door
812 door switch
82 jig table
83 input/output device
84 control device
85 operator
86 articulated robot
861 tip arm portion
862 attachment
AP processing application
CL13, CL18, CL13A axis
Fg dead weight
F1 to F3, F21 to F24 force
F1h, F1v component force
G center of gravity
LS laser beam
M motor
Ma pinion
N1, N2 lock bolt
SK handheld welding torch mounting structure
Wa, Wb distance
W7 housing width

1. A handheld welding torch mounting structure comprising:
a mounting portion fixed to an arm of a robot;
a rectangular base plate formed integrally with the mounting portion for placing a handheld welding torch;
a first side plate supported on a first edge of the base plate so as to be rotatable in an opening direction from an upright posture; and
a second side plate fixed in an upright posture to a second edge opposite to the first edge, wherein
the handheld welding torch is mounted on the arm by being clamped and held between the first side plate and the second side plate raised in a state of being placed on the base plate.

2. The handheld welding torch mounting structure according to claim 1, further comprising
a clamp plate that connects and fixes the first side plate and the second side plate.

3. The handheld welding torch mounting structure according to claim 1, wherein each of the first side plate and the second side plate has a bolt that presses against the clamped handheld welding torch by being screwed.

4. The handheld welding torch mounting structure according to claim 2, wherein each of the first side plate and the second side plate has a bolt that presses against the clamped handheld welding torch by being screwed.

5. The handheld welding torch mounting structure according to claim 3, wherein the bolt is a resin bolt.

6. The handheld welding torch mounting structure according to claim 4, wherein the bolt is a resin bolt.
